(19) United States
(12) Patent Application Publication
(10) Pub. No.: US 2026/0219838 A1
(43) Pub. Date: Jul. 30, 2026

(54) REPLACING MULTIPLIERS WITH LUTS IN AN AI ENGINE

(71) Applicant: XILINX, INC., San Jose, CA (US)

(72) Inventors: Juan J. NOGUERA SERRA, San Jose, CA (US); Francisco BARAT QUESADA, Erembodegem (BE)

(21) Appl. No.: 19/040,725

(22) Filed: Jan. 29, 2025

(51) Int. Cl. G06F 7/523; G06N 3/0464

(52) U.S. Cl. CPC G06F 7/523; G06N 3/0464

(57) ABSTRACT

Embodiments herein describe an artificial intelligence (AI) engine including circuitry to divide a first operand into multiple groups, populate a lookup table (LUT) from multiple multiplications performed by the first operand with bit-groups of a second operand, and reuse the LUT across the bit-groups of the second operand. The first operand remains static for multiple cycles. In a first cycle, the first operand is used to pre-populate the LUT and, in subsequent cycles, the second operand is used to index the LUT. Indexing the LUT includes memory accesses configured to reduce power consumption.

### TECHNICAL FIELD

Examples of the present disclosure generally relate to artificial intelligence (AI) engines, and, in particular, to replacing at least some multipliers with look-up tables (LUTs) in the AI engine.

### BACKGROUND

Graphics processing units (GPUs) are equipped with a large number of multipliers to efficiently handle the vast number of multiplication operations involved in artificial intelligence/machine learning (AI/ML) models. In deep learning, operations like matrix multiplications and convolutions are fundamental to tasks such as forward propagation in neural networks, where inputs are multiplied by weights to compute outputs. The sheer volume of these operations, especially in large models with millions or billions of parameters, involves hardware that can perform multiplications in parallel to achieve high throughput.

GPUs are designed with thousands of cores, each capable of executing multiple multiplication operations simultaneously. This parallelism allows GPUs to process large datasets and perform the necessary calculations for tasks like training neural networks and real-time inference. Specialized hardware components like tensor cores further accelerate matrix operations, significantly speeding up AI workloads. The use of many multipliers enables GPUs to handle the heavy computational demands of AI/ML, making them essential for tasks ranging from image recognition to natural language processing. However, multipliers are power-hungry components, which leads to high power consumption resulting in energy inefficiency and multipliers can also occupy a considerable amount of die space making chips costlier to manufacture.

### SUMMARY

One example described herein is an artificial intelligence (AI) engine including circuitry to divide a first operand into multiple groups, populate a lookup table (LUT) from multiple multiplications performed by the first operand with bit-groups of a second operand, and reuse the LUT across the bit-groups of the second operand. The first operand remains static for multiple cycles. The first operand and the second operand are each represented in a binary format. Each of the bit-groups of the second operand include a predefined range of constant values. Further, in a first cycle, the first operand is used to pre-populate the LUT and, in subsequent cycles, the second operand is used to index the LUT. Indexing the LUT includes memory accesses configured to reduce power consumption.

One example described herein is a method including dividing a first operand into multiple groups , populating a lookup table (LUT) from multiple multiplications performed by the first operand with bit-groups of a second operand , and reusing the LUT across the bit-groups of the second operand.

One example described herein is a processor including one or more artificial intelligence (AI) engines, each AI engine having circuitry to divide a first operand into multiple groups, populate a lookup table (LUT) from multiple multiplications performed by the first operand with bit-groups of a second operand, and reuse the LUT across the bit-groups of the second operand.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 illustrates replacing at least some multipliers with look-up tables (LUTs), according to an example.

FIG. 2A illustrates using a LUT of size 4, according to an example.

FIG. 2B illustrates using a LUT of size 8, according to an example.

FIG. 3 is a block diagram of an accelerator unit (AU) configured to execute workloads for applications running on a processing system, according to an example.

FIG. 4 illustrates a method for replacing at least some multipliers with LUTs in an AI engine, according to an example.

FIG. 5 illustrates an artificial intelligence (AI) engine including multiple multipliers and LUTs, according to an example.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the examples herein or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

An artificial intelligence (AI) engine or AI engine core is a specialized processing unit used to accelerate AI and machine learning (ML) tasks. These AI engine cores are optimized for the computational requirements of AI workloads, which involve extensive mathematical operations, large datasets, and high parallelism. AI engine cores feature architectures tailored to handle AI workloads. This may include optimized instruction sets, data paths, and memory hierarchies that facilitate efficient processing of matrix and vector operations found in neural networks. AI engine cores are used to perform many calculations simultaneously, leveraging data parallelism inherent in AI algorithms.

AI engine cores include multipliers. A multiplier is a digital circuit or device used to perform multiplication operations on numerical values, usually in binary form. A multiplier is a fundamental component in various computing systems, including processors, digital signal processors (DSPs), graphics processing units (GPUs), and AI accelerators. A multiplier takes two input values (operands) and produces a single output value that is the product of those operands.

In AI/ML applications, multiply operations are beneficial for forward pass in neural networks, convolutional neural networks (CNNs), and backpropagation and gradient descent. During the forward pass, the input data is multiplied by the weights of the neural network at each layer. For fully connected layers, this involves matrix multiplication between the input and the weight matrix. In CNNs, multiply operations happen when the filter (kernel) is applied to patches of the input image. Each element of the filter is multiplied by the corresponding pixel value in the image patch, and the results are summed to form the output feature map. During training, multiply operations are used to compute gradients (partial derivatives) of the loss function with respect to the weights and inputs, so that the model can adjust the weights to minimize the loss.

However, using too may multipliers in AI engines or GPUs can introduce disadvantages that impact efficiency, cost, and overall functionality. The disadvantages may include increased power consumption, silicon area overhead, underutilization in non-compute-intensive workloads, and increased complexity in design and verification. Adding more multipliers significantly increases the power draw, which can strain the power delivery system. If multipliers are not fully utilized during execution, this area effectively becomes wasted silicon. Unused multipliers still consume static power and contribute to leakage currents.

In view of such challenges, the examples present a method and system for replacing at least some multipliers with look-up tables (LUTs). In this optimized methodology, LUTs are used as an efficient substitute for multipliers, such as when one operand remains constant or changes infrequently. During the first cycle, this operand is used to populate the LUT with precomputed results. These results correspond to the product of the first operand and a predefined range of constant values (e.g., 0 to 3). In subsequent cycles, the second operand, broken down in pieces or groups, serves as an index to the LUT, allowing the AI engine to directly retrieve the desired product without performing an explicit multiplication. Multiple multiplications are performed using a first operand (or static operand). As such, the cost of pre-computing the LUT is amortized over many multiplications. This helps achieve a reduction in power consumption as the first operand includes less addition operations.

The advantage of this approach lies in its ability to save memory and eliminate redundant calculations. Traditional implementations repeatedly store intermediate results in local memory or depend on direct multiplications, both of which can be resource-intensive. By precomputing and caching these results in a LUT, the system avoids the need to store large temporary arrays or perform frequent read/write cycles in local memory. This reduction in memory traffic not only saves energy but also reduces latency, as memory accesses are often a bottleneck in high-speed computation. Consequently, the combined multiplier-LUT architecture is well-suited for dataflow-driven AI/ML accelerators, where minimizing data movement is beneficial.

Furthermore, the hybrid approach is particularly beneficial for workloads involving fixed-point arithmetic or quantized neural networks. In these applications, the limited precision of operands makes the LUT implementation feasible within reasonable memory constraints. By leveraging this efficiency, AI/ML accelerators can focus their silicon budget on other functions, such as expanding parallelism or improving interconnect bandwidth, rather than deploying excessive multipliers.

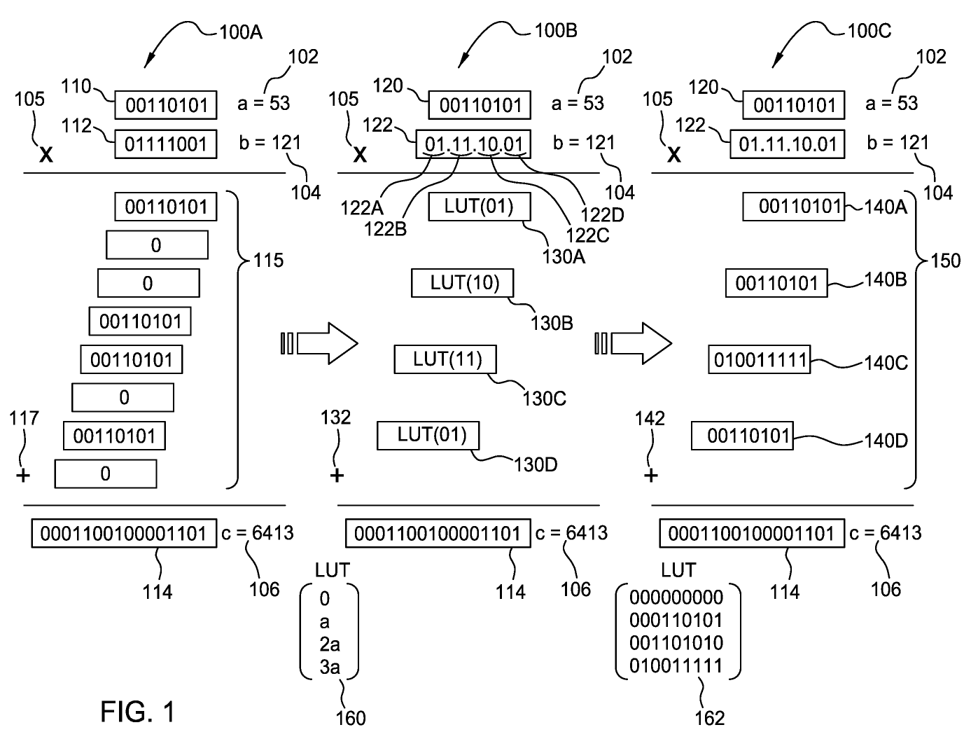

FIG. 1 illustrates replacing at least some multipliers with look-up tables (LUTs), according to an example.

Operation 100A shows a first operand 102 (designated as “a” or “A”) and a second operand 104 (designated as “b” or “B”). In one example, for illustrative purposes, the first operand 102 is 53 and the second operand 104 is 121. The first operand 102 may be represented as an 8-bit operand 110 (e.g., 00110101) and the second operand 104 may be represented as an 8-bit operand 112 (e.g., 01111001). The operation 100A shows how to multiply two numbers, that is, 53 and 121. To multiply the two 8-bit operands and compute the partial sums, the operation involves binary multiplication 105, where each bit of the multiplier is ANDed by one multiplicand bit, resulting in partial products 115.

The first operand 102 is the multiplier and the second operand 104 is the multiplicand. Each bit in the multiplier (i.e., the first operand 102) is ANDed by one multiplicand bit (i.e., of the second operand 104). When multiplying by a bit of the multiplier at position i, the resulting row (partial product) is shifted i-positions to the left. Then all the shifted partial products are added together. Binary addition is carried out starting from the least significant bit.

The partial products 115 are then shifted and added together (e.g., by adder 117) to form a final result 106. The final result 106 is 6413 (i.e., A x B = 53 x 121). The final result 106 may be designated as “c” or “C.” The final result 106 may also be designated as a 16-bit result 114 (e.g., 0001100100001101). As such, the operation 100A involves breaking down or dividing the multiplication into partial products, aligning the partial products based on the multiplier bit’s position, and adding all the partial products to obtain the final result.

Operation 100B shows the first operand 102 (designated as “a” or “A”) and the second operand 104 (designated as “b” or “B”). In one example, for illustrative purposes, the first operand 102 is 53 and the second operand 104 is 121. The first operand 102 may be represented as an 8-bit operand 120 (e.g., 00110101) and the second operand 104 may be represented as an 8-bit operand 122 (e.g., 01111001). The operation 100B shows how to multiply two numbers, that is, 53 and 121. To multiply the two 8-bit operands and compute the partial sums, the operation involves binary multiplication 105. However, in contrast to the operation 100A, in the operation 100B, the second operand 104 is split or divided into groups of two bits. The first group 122A of two bits is (01), the second group 122B of two bits is (11), the third group 122C of two bits is (10), and the fourth group 122D of two bits is (01). The groups are shown separated by a period (.).

After breaking down or dividing each 8-bit operand into four two-bit groups, a single LUT is created or generated for all possible multiplications of the first operand 102 by an operand of two bits. For example, the first group 122A of two bits is (01) (i.e., LUT(01) = operand 1 x 0), the second group 122B of two bits is (10) (i.e., LUT(10) = operand 1 x1), the third group 122C of two bits is (11) (i.e., LUT(11) – operand 1 x 3), and the fourth group 122D of two bits is (01)(i.e., operand 1 x 3) are used to create the single LUT . A table 162 includes the four results obtained by multiplying the full first operand by 0, 1, 2, and 3. As such, the values are not computed. Instead, the values are stored in respective LUTs. The two-bit groups are used to perform a lookup from the respective LUTs. In other words, lookups (i.e., multiplication lookups) are performed for each pair of two-bit groups. The results from the LUT are shifted based on their significance in the overall binary number. Then, the shifted results are combined or added by binary addition (e.g., by adder 132) to form the final result 106. The final result 106 may be designated as “c” or “C.” The final result 106 may also be designated as a 16-bit result 114 (e.g., 0001100100001101). Instead of 8 additions, this method allows for 4 memory lookups or 4 memory accesses via the four LUTs. This further results in only 4 additions instead of 8 additions shown in the operation 100A.

The advantages of LUT-based multiplication include avoiding complex computations, scalability, and parallelism. For example, the multiplication is reduced to a memory access operation. LUT size depends on the chunk size. As such, larger LUTs can handle bigger operands if memory is available. Further, multiple lookups and additions can be parallelized for faster results. This method trades off memory usage for computational simplicity and speed. Moreover, replacing multipliers with LUTs reduces power consumption in computation. Multipliers use multiple stages of adders, shift registers, and carry propagation logic, which consume significant power during operation. LUTs, on the other hand, use simply memory accesses to retrieve values, avoiding the need for runtime arithmetic. LUTs operate primarily through memory lookups, where static power is dominant. In comparison, multipliers involve dynamic switching power from many transitions toggling during arithmetic operations.

Therefore, 8-bit multiplication using two-bit LUTs involves breaking down or dividing or splitting the operand into chunks or two-bit groups, performing memory lookups, and combining the results with simple shifts and additions.

Operation 100C shows the first operand 102 (designated as “a” or “A”) and the second operand 104 (designated as “b” or “B”). In one example, for illustrative purposes, the first operand 102 is 53 and the second operand 104 is 121. The first operand 102 may be represented as an 8-bit operand 120 (e.g., 00110101) and the second operand 104 may be represented as an 8-bit operand 122 (e.g.,01111001). In accordance with the operation 100B, the second operand has been split or divided into four two-bit groups separated by a period (.). The first operand 102 is multiplied by the second operand 104 divided into four two-bit groups using the binary multiplication 105. This involves storing the four binary representation of the product of the first operand times 0, 1, 2, and 3. The first binary representation 140A is 00110101, the second binary representation 140B is 00110101, the third binary representation 140C is 010011111, and the fourth binary representation 140D is 00110101. The binary representations 150 are added or combined by the adder 142 to form the final result 106. The final result 106 may be designated as “c” or “C.” The final result 106 may also be designated as a 16-bit result 114 (e.g.,0001100100001101). Instead of 8 additions, this method allows for 4 memory lookups or 4 memory accesses via the four LUTs. This further results in only 4 additions instead of 8 additions shown in the operation 100A.

The LUTs can be represented as a table 160 with four rows and one column. The first row is “0,” the second row is “a,” the third row is “2a,” and the fourth row is “3a.” The table 160 represents the four LUTs. The precomputed values of the LUTs are shown in table 162. The pre-computed values are, e.g., for the first LUT 130A (000000000), for the second LUT 130B (000110101), for the third LUT 130C (001101010), and for the fourth LUT 130D (010011111). In other words, for the first operand 102, for the first row it is multiplied by zero, for the second row it is multiplied by 1 putting the same operand, for the third row it is multiplied by 2 to shift the digits by 1, and for the fourth row it is multiplied by 3 to add the terms together. As such, the table 162 is precomputed while the multiplication is being set up. One advantage is that when many numbers need to be multiplied by the second factor, the LUT is computed only once, which results in energy savings.

Stated differently, the LUT is computed only using the first operand 102. The groups of two bits of the second operand 104 are used to address or index the LUT. As such, in the first cycle, the first operand 102 is used to pre-populate the LUTs. In subsequent cycles, the hardware extracts each two-bit group of the second operand 104. Each group is used as an index to the corresponding LUT to retrieve the partial product. The partial products from all the LUTs are then shifted and added together to form the final result (i.e., operand A x operand B = result C). This approach replaces further multiplication operations with fast memory accesses, improving speed since memory lookups are generally faster than real-time multiplications.

By splitting the second operand 104 into smaller groups, the size of each LUT is significantly reduced. Each LUT only needs to store results for values 0 through 3, involving 4 entries. The reduced LUT size minimizes memory requirements, allowing for better hardware scaling. Simultaneous lookups for all two-bit groups is enabled, which increases the throughput of the multiplication process. As such, in this approach, an 8-bit operand is split into four groups of two bits each, where each of the four groups index the LUT to facilitate efficient computation by using memory access to retrieve precomputed results based on the two-bit groups. The content of the LUT is the other operand multiplied by a range of constants (e.g., 0, 1, 2, and 3). Moreover, the first operand 102 remains static or constant for many cycles (e.g., 16 or 32 cycles). For a first cycle, a LUT is updated, but for remaining or subsequent cycles, only LUT memory access operations need to be performed, not multiplications, as the first operand 102 is static or constant for a larger number of cycles.

The static first operand is a fixed value used across many operations. Because the first operand does not change, its properties can be pre-computed, covering possible values of the second operand. The upfront cost of pre-computing the table is amortized (spread out) over many multiplications.

By fixing one operand, the system avoids repeated calculations involving that operand across multiple cycles. Multiplication between numbers can be thought of as adding shifted versions of one operand based on the bits of the other operand. Each bit of the multiplier determines whether the multiplicand is added to the intermediate sum. If the multiplier has fewer non-zero bits, the number of additions needed is reduced. The reduction in additions directly correlates to a decrease in the energy consumed by each multiplication. Additions involve switching activity in logic gates, and fewer additions translate to fewer transitions. While the same number of multiplications are performed, hardware optimizations lower the energy overhead of implementing each multiplication. Stated differently, the gain from reducing additions in multiplication stems from a shift in how the partial products are generated and accumulated. The example optimizations do not reduce the number of multiplications but instead focus on making each multiplication more energy-efficient by lowering the associated computational overhead (i.e., reduce additions needed to implement the multiplication).

Precomputing values using the static operand and storing them in a LUT allows for fast lookups in subsequent cycles, replacing some of the additions in the multiplier (i.e., the first operand). Accessing the LUT is usually less power-hungry than performing the full multiplier operation.

Keeping one operand static means less switching activity in the arithmetic units and associated logic circuits. Digital circuits consume power primarily during state transitions (switching), so reducing the number of operations that need state changes results in lower overall power consumption. By reducing the frequency of arithmetic operations (e.g., additions), the dynamic power associated with switching activity in the circuit is decreased.

Lower power consumption leads to reduced thermal output, which can improve the overall thermal management of the system. This is beneficial in high-performance computing environments where heat dissipation can impact performance and reliability. In scenarios where one operand remains constant, other resources can be better utilized for different tasks or to enhance performance for varying workloads, leading to improved system efficiency.

In summary, in one example, the first operand 102 is the multiplier and the second operand 104 is the multiplicand. The first operand 102 serves as the static operand. The first operand 102 (or static operand) is used to address the single LUT. The single LUT is computed using only the first operand 102. Many multiplications are performed by the first operand 102. The single LUT is created for all the multiplications of the first operand 102. The LUT is generated once for the first operand 102 and reused across all bit-groups of the second operand 104. The second operand 104 is divided or broken down into pieces or portions or segments or groups. In one example, the groups of the second operand 104 include four two-bit groups. The second operand 104 serves as an index to the single LUT. As such, the four two-bit groups index the single LUT. In other words, each two-bit group of the second operand 104 can independently index the LUT. Each two-bit group can represent a value between0 and 3. The single LUT includes precomputed partial products of the first operand 102 (multiplier) with all possible two-bit values (i.e., 0, 1, 2, and 3) of the second operand 104. Stated differently, the single LUT includes products (or multiplications) of the first operand 102 by constant terms of the second operand 104 (i.e., 0, 1, 2, 3). The same single LUT can then be reused for all subsequent multiplications involving the same multiplier but different two-bit groups of the second operand. This amortizes the cost of generating the LUT across many multiplications. The cost is reduced because less additions are performed by the first operand 102 (i.e., the multiplier). As such, full multiplier operations are not performed. Instead, LUT access replaces some of the additions inside the first operand 102 (i.e., the multiplier).

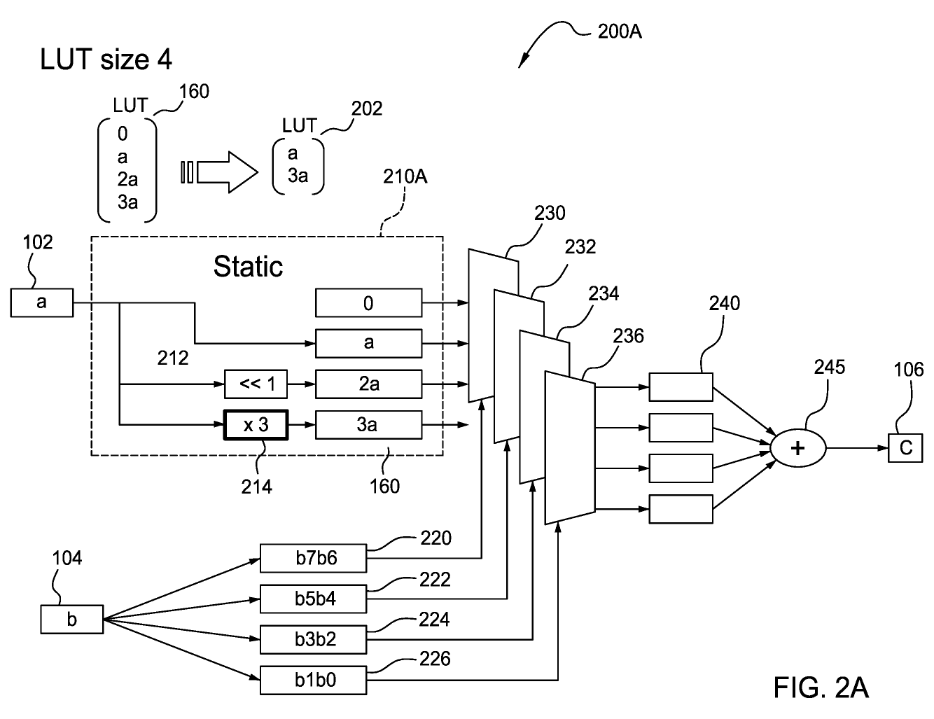

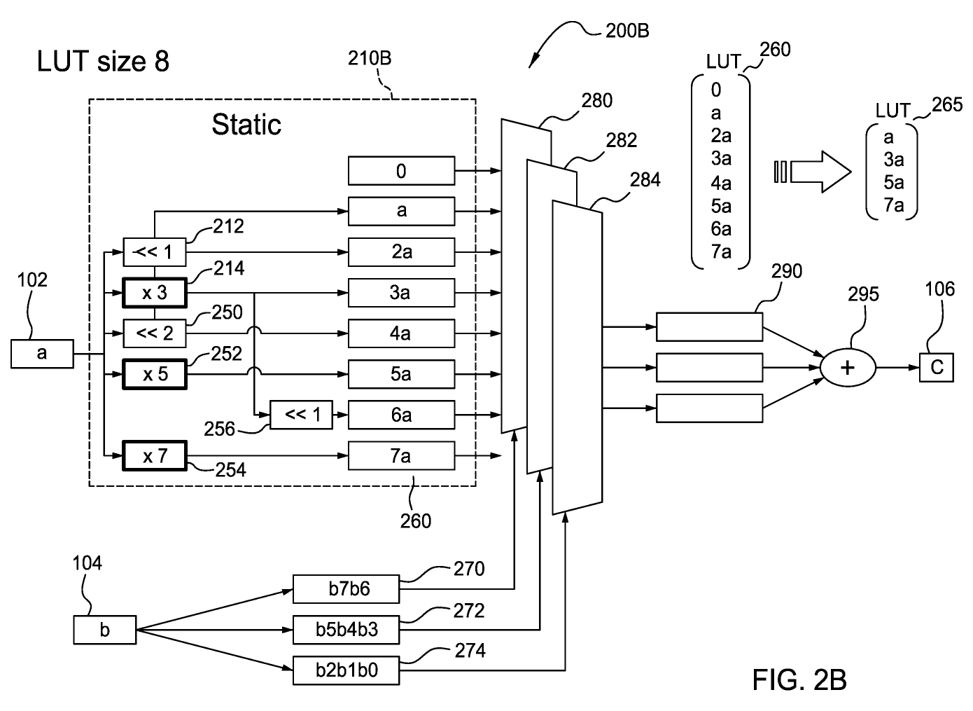

FIG. 2A illustrates using a LUT of size 4, according to an example.

The hardware configuration 200A shows the first operand 102 and the second operand 104. The first operand 102 remains static or constant, which results in values 210A. The values 210A include free operation 212 and actual operation 214. The free operation 212 is a lookup operation and the actual operation 214 is a combined result operation. The free operation 212 includes the precomputed values in the LUT that can be reused without recalculation for repetitive operations and the actual operation 214 includes combined LUT results using shifts and additions to compute the final product.

As such, the table 160 includes the precomputed values in the four LUTs. The precomputed values or pre-populated values can be represented as “0,” “a,” “2a,” and “3a.” The pre-computed values are, e.g., for the first LUT 130A (000000000), for the second LUT 130B (000110101), for the third LUT 130C (001101010), and for the fourth LUT 130D (010011111). In other words, for the first operand 102, for the first row it is multiplied by zero, for the second row it is multiplied by 1 putting the same operand, for the third row it is multiplied by 2 to shift the digits by 1, and for the fourth row it is multiplied by 3 to add the terms together.

The second operand 104, represented in binary form, is divided into groups of bits. The first group 220 includes two bits (b7b6), the second group 222 includes two bits (b5b4), the third group 224 includes two bits (b3b2), and the fourth group 226 includes two bits (b1b0). b7 is the most significant bit and b0 is the least significant bit. Each group is processed independently via lookups in a LUT and combined later.

The multiplexers 230, 232, 234, 236 multiply the static operand (the first operand A) with each two-bit group (of the second operand B). By breaking the second operand B into smaller chunks, parallel units can process each group independently, speeding up the computation. In particular, the first group 220 of two bits (b7b6) is multiplied by zero in the first multiplexer 230, the second group 222 of two bits (b5b4) is multiplied by one in the second multiplexer 232, the third group 224 of two bits (b3b2) is multiplied by two in the third multiplexer 234, and the fourth group 226 of two bits (b1b0) is multiplied by three in the fourth multiplexer 236. The multiplication results in partial products 240, each of which represents a chunk of the multiplication. The partial products 240 are summed (by adder 245) to produce the final multiplication result 106. As such, for a LUT of 4, two bits are combined at a time from the second operand B. The table 160 can be reduced to table 202 including the two actual computations (i.e., “a” and “3a”). In other words, the table 202 includes a reduced form of the table 160. That is, value “0” does not need to be stored and values “a” and “2a” are identical except for a free shift operation that can be performed in the multiplexer. The multiplexers will thus choose one of the values from the LUT table and pass that value to the adder 245. The multiplexer thus provides the contents of a particular entry in the table 160.

FIG. 2B illustrates using a LUT of size 8, according to an example.

The hardware configuration 200B shows the first operand 102 and the second operand 104. The first operand 102 remains static or constant, which results in values 210B. The values 210B include free operations 212, 250, 256 and actual operations 214, 252, 254. The free operations 212, 250, 256 are lookup operations and the actual operations 214, 252, 254 are combined result operations. The free operations 212, 250, 256 include the precomputed values in the LUT that can be reused without recalculation for repetitive operations and the actual operations 214, 252, 254 include combined LUT results using shifts and additions to compute the final product.

As such, the table 260 includes the precomputed values in the LUTs. The precomputed values or pre-populated values can be represented as “0,” “a,” “2a,” “3a,” “4a,” “5a,” “6a,” and “7a.” In other words, for the first operand 102, for the first row it is multiplied by zero, for the second row it is multiplied by 1 putting the same operand, for the third row it is multiplied by 2 to shift the digits by 1, for the fourth row it is multiplied by 3 to further shift the digits, for the fifth row it is multiplied by 4 to further shift the digits, for the sixth row it is multiplied by 5 to further shift the digits, for the seventh row it is multiplied by 6 to further shift the digits, and for the eighth row it is multiplied by 7 to add the terms together.

The second operand 104, represented in binary form, is divided into groups of bits. The first group 270 includes two bits (b7b6), the second group 272 includes three bits (b5b4b3), and the third group 274 includes three bits (b2b1b0). b7 is the most significant bit and b0 is the least significant bit. Each group is processed independently via lookups in a LUT and combined later.

The multiplexers 280, 282, 284 multiply the static operand (the first operand A) with each two-bit or three-bit group (of the second operand B). By breaking down or dividing the second operand B into smaller chunks, parallel units can process each group independently, speeding up the computation. In particular, the first group 270 of two bits (b7b6) is multiplied by pre-computed values in the first multiplexer 280, the second group 272 of three bits (b5b4b3) is multiplied by pre-computed values in the second multiplexer 282, and the third group 274 of three bits (b2b1b0) is multiplied by pre-computed values in the third multiplexer 284. The multiplication results in partial products 290, each of which represents a chunk of the multiplication. The partial products 290 are summed (by adder 295) to produce the final multiplication result 106. As such, for a LUT of 8, two bits are combined at a time and/or three bits are combined at a time from the second operand B. The table 260 can be reduced to table 265 including the four actual computations (i.e., “a,” “3a,” “5a,” and “7a”). That is, value “0” does not need to be stored and values “2a,” “4a,” and “6a” are identical except for a free shift operation that can be performed in the multiplexer. The multiplexers will thus choose one of the values from the LUT table and pass that value to the adder 295. The multiplexer thus provides the contents of a particular entry in the table 260.

In some examples, the first operand 102 and the second operand 104 are each a first size (e.g., 8 bits) and each LUT size is a multiple of the first size. As such, each LUT can be 4 or 8. Stated differently, the width of the LUT is larger than the width of the first operand. The width of the LUT may be the width of the first operand and the width of a group from the second operand, minus one. The number of entries is 2 to the power of the number of bits in a group of the second operand.

Therefore, according to FIGS. 1, 2A, and 2B, reducing the number of additions in a multiplication operation transforms the way partial products are generated and accumulated, leading to energy efficiency gains. Each addition in a digital circuit involves numerous transistor state changes, which is the primary driver of power consumption. By reducing the number of additions, fewer transitions occur, thus lowering the energy consumption per operation. In a practical application involving AI/ML accelerators, matrix multiplications are at the core of neural network workloads, and millions of multiplications are performed in a single inference pass. Reducing the energy per multiplication improves the overall energy efficiency of AI hardware.

The examples have been presented to handle unsigned arithmetic. Unsigned arithmetic represents only non-negative numbers. However, the examples can handle signed arithmetic. Signed arithmetic represents both positive and negative numbers using method like two’s complement. Two’s complement allows for seamless addition, subtraction, and multiplication using the same hardware used for unsigned arithmetic. In such case, the most significant bit of the second operand would use a separate LUT. A table would compute the multiplication by: 0, 1, -2, and -1. As such, the examples can support both signed and unsigned scenarios.

In another example, the operands may be swapped. That is, the first operand (originally the multiplier) and the second operand (originally the multiplicand) can exchange roles. This adjustment may involve reconfiguring the LUT construction and usage. However, the core principles of the architecture remain applicable. Thus, after swapping, the second operand (now the new multiplier) becomes static and is used to index the LUT and the first operand (now the new multiplicand) is divided into groups and used to generate the LUT.

Therefore, while multipliers are valuable for high-performance computations in AI/ML applications, strategically reducing their number in an AI engine core can lead to significant advantages in terms of area and cost savings, power efficiency, resource optimization, design simplicity, and flexibility. By leveraging innovative design strategies such as mixed-precision computing and shared resources, a balanced architecture can be achieved that meets the requirements of AI/ML applications while maintaining high performance and efficiency.

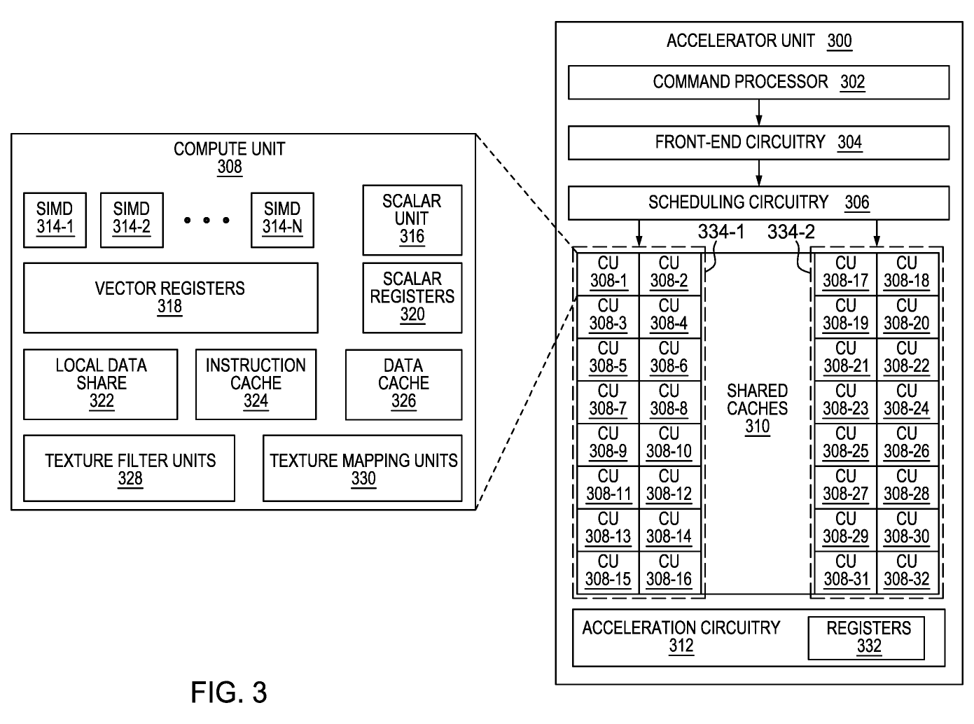

As such, the examples can be applied to AI/ML applications. These applications use algorithms and computational models to analyze data, recognize patterns, and make predictions or decisions without being explicitly programmed. AI/ML applications rely on data, which can be structured (like databases) or unstructured (like text, images, and videos). By analyzing vast amounts of data, these applications can uncover insights that inform decision-making processes. The ability to learn from historical data allows ML models to make predictions about future events, optimize operations, and enhance user experiences. ML encompasses various learning paradigms such as supervised learning, unsupervised learning, and reinforcement learning. Supervised learning involves training a model on a labeled dataset, where the algorithm learns to map input data to the corresponding output. Unsupervised learning deals with unlabeled data, where the model tries to identify patterns or groupings without predefined categories. Reinforcement learning involves training agents to make decisions based on feedback from their actions in an environment. AI/ML applications continuously learn and adapt. As they process more data, they refine their models, improving accuracy and performance over time. AI/ML applications are at the forefront of technological innovation, driving efficiency, personalization, and improved decision-making across various domains. The examples described herein can be implemented for any AI/ML applications. The examples can be further incorporated into any processor, such as an accelerator unit or GPU, as described below with reference to FIG. 3.

In AI/ML applications, especially in convolutional neural networks (CNNs) during the forward pass, computations involve multiplying large tensors of weights (kernels) and input activations. Optimizing these multiplications for hardware acceleration is valuable to improving performance and energy efficiency. The example approach can be applied to CNNs, where weights and activations are represented in low-bit formats (e.g., 2-bit or 4-bit quantization). Here, a lookup table (LUT)-based multiplication method significantly enhances the efficiency of tensor multiplications. In such case, the first operand (e.g., input activation tensor) is divided into multiple groups. For instance, if the operand is an 8-bit value, it can be split into 2-bit chunks. Multiple multiplications are performed between the divided groups of the first operand and 2-bit groups of the second operand (e.g., quantized weights in the kernel).A LUT is populated with the results of these multiplications. The pre-computed LUT values are reused for each bit-group of the second operand. This avoids redundant computations and reduces runtime overhead. In a CNN forward pass, convolution operations between an input feature map and weight kernels are computationally expensive due to the large number of multiplications. LUT-based multiplication minimizes repetitive multiplication, leveraging pre-computed values for reuse across bit-groups. By reusing pre-computed LUTs, the overall runtime of the forward pass is reduced, enabling faster inference for CNNs. The example LUT-based method reduces the number of dynamic multiplications, saving power.

FIG. 3 is a block diagram of an accelerator unit (AU) configured to execute workloads for applications running on a processing system, in accordance with some examples.

FIG. 3 presents an AU 300 configured to execute workloads for one or more applications running on a processing system. These applications include, for example, compute applications, graphics applications, or both each configured to issue respective series of instructions, also referred to herein as “threads,” to a central processing unit (CPU) of the processing system. Compute applications, when executed by a processing system, cause the processing system to perform one or more computations, such as machine-learning, neural network, high-performance computing, or databasing computations. Further, graphics applications, when executed by a processing system, cause the processing system to render a scene including one or more graphics objects and, as an example, output the scene on a display. The instructions issued to the CPU from these applications, for example, include groups of threads, also referred to herein as “workgroups,” to be executed by AU 300. To perform these workgroups, AU 300 includes one or more vector processors, coprocessors, graphics processing units (GPUs), general-purpose GPUs, non-scalar processors, highly parallel processors, artificial intelligence (AI) processors, inference engines, AI engines, AI engine cores, machine-learning processors, or any combination thereof. As an example, AU 300 includes one or more command processors 302, front-end circuitry 304, scheduling circuitry 306, compute units 308, shared caches 310, and acceleration circuitry 312. The acceleration circuitry 312 may include first functional circuitry and second functional circuitry for concurrently performing matrix-matrix and vector-vector instructions and/or operations (parallel execution).

A command processor 302 of AU 300 is configured to receive, from the CPU, a command stream indicating one or more workgroups to be executed. As an example, based on a compute application running on the processing system, the command processor 302 receives a command stream indicating workgroups that involve compute operations such as matrix multiplication, addition, subtraction, and the like to be performed. As another example, based on a graphics application running on the processing system, the command processor 302 receives a command stream indicating workgroups that include draw calls for a scene to be rendered. After receiving a command stream, the command processor 302 parses the command stream and issues respective instructions of the indicated workgroups to front-end circuitry 304, scheduling circuitry 306, or both. As an example, based on a command stream from a graphics application, the command processor 302 issues one or more draw calls to front-end circuitry 304 that includes one or more vertex shaders, polygon list builders, and the like. From the instructions issued from the command processor 302, front-end circuitry 304 is configured to position geometry objects in a scene, assemble primitives in a scene, cull primitives, perform visibility passes for primitives in a scene, generate visible primitive lists for a scene, or any combination thereof. For example, based on a set of draw calls received from a command processor 302, front-end circuitry 304 determines a list of primitives to be rendered for a scene. After determining a list of primitives to be rendered for a scene, the front-end circuitry 304 issues one or more draw calls (e.g., a workgroup) associated with the primitives in the list of primitives to scheduling circuitry 306.

Based on the instructions of the workgroups received from a command processor 302, front-end circuitry 304, or both, scheduler circuitry 306 is configured to provide data indicating threads (e.g., operations for these threads) to be executed for these workgroups to one or more compute units 308. Each compute unit 308 is configured to support the concurrent execution of two or more threads of a workgroup. For example, each compute unit 308 is configured to concurrently execute a predetermined number of threads referred to herein as a “wavefront.” Based on the size of the wavefront of a compute unit 308, scheduler circuitry 306 schedules one or more groups of threads of the workgroup, also referred to herein as “waves,” to be executed by the compute unit 308. As an example, scheduler circuitry 306 first updates one or more registers of a compute unit 308 such that the compute unit 308 is configured to execute a first group of waves of the workgroup. After the compute unit 308 has executed the first group of waves, scheduler circuitry 306 updates one or more registers of the compute unit 308 to schedule a second group of waves of the workgroup to be executed by the compute unit 308. To execute these waves, each compute unit is connected to one or more shared caches 310 that each include a volatile memory, non-volatile memory, or both accessible by one or more compute units 308. These shared caches 310, for example, are configured to store data (e.g., register files, values, operands, instructions, variables) used in the execution of one or more waves, data resulting from the performance of one or more waves, or both. Because a shared cache 310 is accessible by two or more compute units 308, a first compute unit 308 is enabled to provide results from the execution of a first wave to a second compute unit 308 executing a second wave. Though the example presented in FIG. 3 shows AU 300 as including 32 compute units (308-1 to 308-32), in other implementations, AU 300 can include any number of compute units 308.

Each compute unit 308 includes one or more single instruction, multiple data (SIMD) units 314, a scalar unit 316, vector registers 318, scalar registers 320, local data share 322, instruction cache 324, data cache 326, texture filter units 328, texture mapping units 330, or any combination thereof. A SIMD unit 314 (e.g., a vector processor) is configured to concurrently perform multiple instances of the same operation for a wave. For example, a SIMD unit 314 includes two or more lanes each including an arithmetic logic unit (ALU) and each configured to perform the same operation for the threads of a wave. Though the example presented in FIG. 3 shows a compute unit 308 including three SIMD units (314-1, 314-2, 314-N) representing an N number of SIMD units, in other implementations, a compute unit 308 can include any number of SIMD units 314. Further, as an example, the size of a wavefront supported by AU 300 is based on the number of SIMD units 314 included in each compute unit 308. To determine the operations performed by the SIMD units 314, each compute unit 308 includes vector registers 318 formed from one or more physical registers of AU 300. These vector registers 318 are configured to store data (e.g., operands, values) used by the respective lanes of the SIMD units 314 to perform a corresponding operation for the wave. Additionally, each compute unit 308 includes a scalar unit 316 configured to perform scalar operations for the wave. As an example, the scalar unit 316 includes an ALU configured to perform scalar operations. To support the scalar unit 316, each compute unit 308 includes scalar registers 320 formed from one or more physical registers of the AU 300. These scalar registers 320 store data (e.g., operands, values) used by the scalar unit 316 to perform a corresponding scalar operation for the wave.

Further, each compute unit 308 includes a local data share 322 formed from a volatile memory (e.g., random-access memory) accessible by each SIMD unit 314 and the scalar unit 316 of the compute unit 308. That is to say, the local data share 322 is shared across each wave concurrently executing on the compute unit 308. The local data share 322 is configured to store data resulting from the execution of one or more operations for one or more waves, data (e.g., register files, values, operands, instructions, variables) used in the execution of one or operations for one or more waves, or both. As an example, the local data share 322 is used as a scratch memory to store results necessary for, aiding in, or helpful for the performance of one or more operations by one or more SIMD units 314. The instruction cache 324 of a compute unit 308, for example, includes a volatile memory, non-volatile memory, or both configured to store the instructions to be executed for one or more waves to be executed by the compute unit 308. Further, the data cache 326 of a compute unit 308 includes a volatile memory, non-volatile memory, or both configured to store data (e.g., register files, values, operands, variables) used in the execution of one or more waves by the compute unit 308. The instruction cache 324, data cache 326, shared caches 310, and a system memory, for example, are arranged in a hierarchy based on the respective sizes of the caches. As an example, based on such a cache hierarchy, a compute unit 308 first requests data from a controller of a corresponding data cache 326. Based on the data not being in the data cache 326, the data cache 326 requests the data from a shared cache 310 at the next level of the cache hierarchy. The caches then continue in this way until the data is found in a cache or requested from the system memory, at which point, the data is returned to the compute unit 308. Additionally, each compute unit 308 includes one or more texture mapping units 330 each including circuitry configured to map textures to one or more graphics objects (e.g., groups of primitives) generated by the compute units 308. Further, each compute unit 308 includes one or more texture filter units 328 each having circuitry configured to filter the textures applied to the generated graphics objects. For example, the texture filter units 328 are configured to perform one or more magnification operations, anti-aliasing operations, or both to filter a texture.

Additionally, to help perform instructions for one or more workgroups, AU 300 includes acceleration circuitry 312. Such acceleration circuitry 312 includes hardware (e.g., fixed-function hardware) configured to execute one or more instructions for one or more workgroups. As an example, acceleration circuitry 312 includes one or more instances of fixed function hardware configured to encode frames, encode audio, decode frames, decode audio, display frames, output audio, perform matrix multiplication, or any combination thereof. To schedule instructions for execution on such hardware, scheduling circuitry 306 is configured to update one or more physical registers 332 of AU 300 associated with the hardware. In some cases, AU 300 includes one or more compute units 308 grouped into one or more shader engines 334. Referring to the example presented in FIG. 3, for example, AU 300 includes compute units 308-1 to 308-16 grouped in a first shader engine 334-1 and compute units 308-17 to 308-32 grouped in a second shader engine 334-2. Such shader engines 334, for example, are configured to execute one or more workgroups (e.g., one or more compute kernels) for an application and include one or more compute units 308, graphics processing hardware (e.g., primitive assemblers, rasterizers), one or more shared caches 310, render backends, or any combination thereof. Though the example presented in FIG. 3 shows AU 300 as including two shader engines (334-1, 334-2), in other implementations, AU 300 can include any number of shader engines (334-1, 334-2).

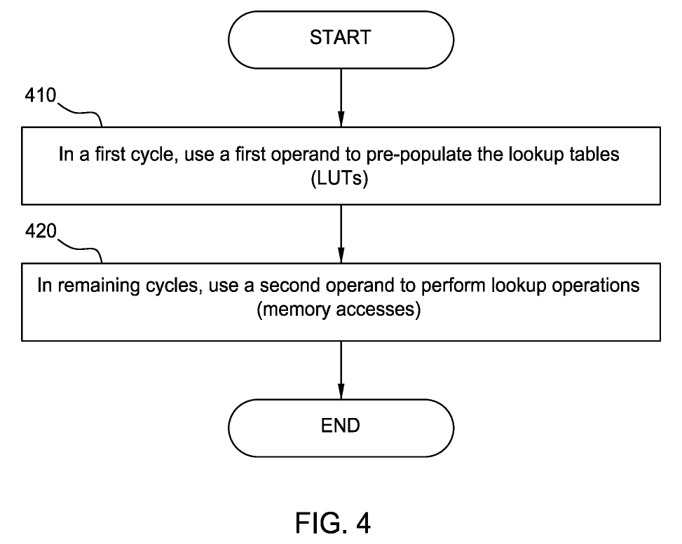

FIG. 4 illustrates a method for replacing at least some multipliers with LUTs in an AI engine, according to an example.

At 410, in a first cycle, a first operand is used to populate the LUTs. During the first cycle, this operand is used to populate the LUT with precomputed results. These results correspond to the product of the first operand and a predefined range of constant values (e.g., 0 to 3).

At 420, in remaining cycles, a second operand is used to perform lookup operations, that is, memory accesses. In subsequent cycles, the hardware extracts each two-bit group of the second operand. Each group is used as an index to the corresponding LUT to retrieve the partial product. The partial products from all the LUTs are then shifted and added together to form the final result (i.e., operand A x operand B = result C). This approach replaces further multiplication operations with fast memory accesses, improving speed since memory lookups are generally faster than real-time multiplications.

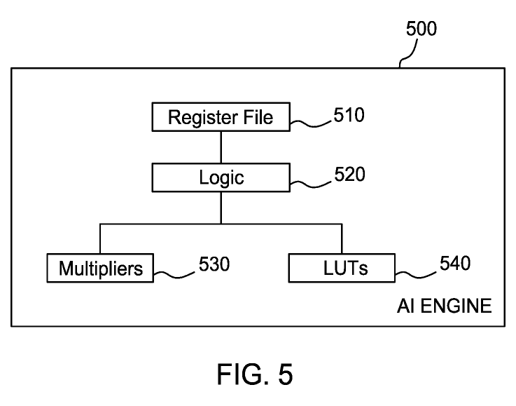

FIG. 5 illustrates an artificial intelligence (AI) engine including multiple multipliers and LUTs, according to an example.

The AI engine 500 includes a register file 510 for storing data. The register file 510 communicates with one or more multipliers 530 and LUTs 540 via logic 520.

The AI engine includes circuitry such as, but not limited to, multipliers, adders, caches, control logic, custom AI/ML circuits or units for performing operations such as activation functions, pooling, and normalization, and power management circuits.

The register file 510 in the AI engine 500 is a small, high-speed storage area that holds a set of registers used for temporarily storing data during computation. The register file 510 stores intermediate values and operands that are actively used during computations, allowing for quick access by the processing units. The register file 510 can accommodate various data types (e.g., integers, floating-point numbers, fixed-point representations, block floating points, etc.) used in AI computations. Many AI engine cores support mixed precision to optimize performance and resource utilization.

The logic 520 of the AI engine 500 enables communication between the register file 510 and the one or more multipliers 530 and the LUTs 540 for replacing at least some multipliers with LUTs in the AI engine 500.

In operation, the register file 510 temporarily holds data during processing. The register file 510 facilitates efficient data movement to/from the one or more multipliers 530 and the LUTs 540 via the logic 520. The logic 520 can help replace multipliers with LUTs to provide an effective way to reduce multiplication operations, save power, and use less die space. LUTs can act as effective replacements for multipliers. If one or both operands have a small range of possible values, precomputing results for all combinations may be feasible. If certain multiplication patterns or values are frequently reused, LUTs can store these precomputed results. The logic 520 implements features to effectively use LUTs by, e.g., precomputing results, indexing and control, adaptive selection, and hybrid implementation.

Multipliers are fundamental in AI and computing. Multiplication is a fundamental operation in many computational tasks, such as convolution, matrix operations, and polynomial evaluations. In AI and ML, multipliers are heavily used for matrix-matrix and matrix-vector multiplications in tasks like neural network training and inference. Hardware multipliers are orders of magnitude faster and more energy-efficient than performing multiplication in software using basic arithmetic operations. Multipliers are used in multiply-accumulate (MAC) units, which are valuable for performing tensor operations in AI workloads. As such, a multiplier is an indispensable building block in digital systems and AI engines, enabling fast and efficient arithmetic operations. However, using too many multipliers can result in increased power consumption, silicon area overhead, underutilization in non-compute-intensive workloads, higher cost of manufacturing, and increased complexity in design and verification. As such, replacing at least some multipliers with LUTs is advantageous for performing AI/ML application in an optimized manner.

In conclusion, the examples involve a method and system for replacing at least some multipliers with look-up tables (LUTs). In this optimized methodology, LUTs are used as an efficient substitute for multipliers, such as when one operand remains constant or changes infrequently. During the first cycle, this operand is used to populate the LUT with precomputed results. These results correspond to the product of the first operand and a predefined range of constant values (e.g., 0 to 3). In subsequent cycles, the second operand, broken down in pieces or groups, serves as an index to the LUT, allowing the AI engine to directly retrieve the desired product without performing an explicit multiplication. Multiple multiplications are performed using a first operand (or static operand). As such, the cost of pre-computing the LUT is amortized over many multiplications. This helps achieve a reduction in power consumption as the first operand includes less addition operations. In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the "C" programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. An artificial intelligence (AI) engine comprising:
circuitry configured to:
divide a first operand into multiple groups;
populate a lookup table (LUT) from multiple multiplications performed by the first operand with bit-groups of a second operand; and
reuse the LUT across the bit-groups of the second operand.

2. The AI engine of claim 1, wherein the first operand remains static for multiple cycles.

3. The AI engine of claim 1, wherein each of the bit groups independently indexes the LUT.

4. The AI engine of claim 1, wherein the LUT includes precomputed partial multiplications of the first operand with two-bit values of the second operand.

5. The AI engine of claim 1, wherein, in a first cycle, the first operand is used to pre-populate the LUT and, in subsequent cycles, the second operand is used to index the LUT, the indexing including memory accesses configured to reduce power consumption.

6. The AI engine of claim 1, wherein the multiple multiplications include multiplying tensors of weights and input activations during a forward pass in a convolutional neural network (CNN).

7. The AI engine of claim 1, wherein the first operand includes input activations, the second operand includes quantized weights in a kernel, the LUT is populated with values of multiplication between the input activations and the quantized weights in the kernel, and the LUT is reused to enable faster inference for a neural network.

8. A method comprising:
dividing a first operand into multiple groups;
populating a lookup table (LUT) from multiple multiplications performed by the first operand with bit-groups of a second operand; and
reusing the LUT across the bit-groups of the second operand.

9. The method of claim 8, wherein the first operand remains static for multiple cycles.

10. The method of claim 8, wherein each of the bit groups independently indexes the LUT.

11. The method of claim 8, wherein the LUT includes precomputed partial multiplications of the first operand with two-bit values of the second operand.

12. The method of claim 8, wherein, in a first cycle, the first operand is used to pre-populate the LUT and, in subsequent cycles, the second operand is used to index the LUT, the indexing including memory accesses configured to reduce power consumption.

13. The method of claim 8, wherein the multiple multiplications include multiplying tensors of weights and input activations during a forward pass in a convolutional neural network (CNN).

14. The method of claim 8, wherein the first operand includes input activations, the second operand includes quantized weights in a kernel, the LUT is populated with values of multiplication between the input activations and the quantized weights in the kernel, and the LUT is reused to enable faster inference for a neural network.

15. A processor comprising:
one or more artificial intelligence (AI) engines, each AI engine having circuitry configured to:
divide a first operand into multiple groups;
populate a lookup table (LUT) from multiple multiplications performed by the first operand with bit-groups of a second operand; and
reuse the LUT across the bit-groups of the second operand.

16. The processor of claim 15, wherein the processor is a graphics processing unit (GPU).

17. The processor of claim 15, wherein the first operand remains static for multiple cycles.

18. The processor of claim 15, wherein the LUT includes precomputed partial multiplications of the first operand with two-bit values of the second operand.

19. The processor of claim 15, wherein, in a first cycle, the first operand is used to pre-populate the LUT and, in subsequent cycles, the second operand is used to index the LUT, the indexing including memory accesses configured to reduce power consumption.

20. The processor of claim 15, wherein the first operand includes input activations, the second operand includes quantized weights in a kernel, the LUT is populated with values of multiplication between the input activations and the quantized weights in the kernel, and the LUT is reused to enable faster inference for a neural network.
